(19) United States
(12) Patent Application Publication
(10) Pub. No.: US 2022/0298442 A1
(43) Pub. Date: Sep. 22, 2022

(54) FUEL COMPOSITION

(71) Applicant: SHELL OIL COMPANY, HOUSTON, TX (US)

(72) Inventors: Matthijs Pieter KOOT, Vondelingenplaat Rotterdam (NL); Howard Barrett LEVINSKY, Groningen (NL); Sander GERSEN, Groningen (NL); Vincent Martijn VAN ESSEN, Groningen (NL); Max Bernhard Friedrich KOFOD, Hamburg (DE); Fenna Iona SLEESWIJK VISSER, Rijswijk (NL); Gerardus Hugo Jozef VAN DIJK, Groningen (NL)

(21) Appl. No.: 17/635,526

(22) PCT Filed: Aug. 6, 2020
(86) PCT No.: PCT/EP2020/072115

§ 371 Date: Feb. 15, 2022

(30) Foreign Application Priority Data
Aug. 16, 2019 (EP) 19192096.6

(51) Int. Cl. C10L 1/185; C10L 3/06; C10L 10/00; C10L 1/02

(52) U.S. Cl. CPC C10L 1/1852; C10L 3/06; C10L 10/00; C10L 1/026; C10L 2270/026; C10L 2230/22

(57) ABSTRACT

A fuel composition wherein the fuel composition comprises (a) a major amount of liquefied methane based gas in cryogenic state having a temperature in the range from −182° C. to −100° C. and, preferably, a pressure in the range of 1 bar to 15 bar, and (b) a minor amount of an 5 ignition improving additive, wherein the ignition improving additive has a melting point of less than −105° C., a boiling point of less than 60° C. and an autoignition temperature of lower than 480° C. and wherein the ignition improving additive is selected from alkanes, alkenes, alcohols, ethers, alkynes, aldehydes, ketones, amides, nitroalkanes, nitrosoalkanes, nitrates, nitrites, cycloalkanes, cycloalkenes, dienes, peroxides, triatomic oxygen, trimethylamine, ethylene oxide, propylene oxide, and mixtures thereof.

### FIELD OF THE INVENTION

The present invention relates to a fuel composition and in particular, to a liquefied fuel composition comprising liquefied methane based gas in a cryogenic state which is suitable for use in an internal combustion engine, especially a compression ignition internal combustion engine. The present invention also relates to a process for producing said liquefied fuel composition.

### BACKGROUND OF THE INVENTION

Natural gas, consisting mainly of methane, has a significant CO₂ advantage over crude oil based fuels and burns more cleanly. Even higher CO₂ advantages are provided by methane from biogas production (biomethane) and from power-to-gas (power-to-methane) plants. This renewable methane production is attractive as it could be done with higher efficiency compared to other renewable fuel production pathways.

When it comes to the use of methane as fuel for mobility and transport, methane gas must be converted into a storable form. Liquefaction of methane provides a fuel with the necessary energy density to store larger amounts of fuel compared to the pressurized storage of methane in the gaseous state. Liquefied natural gas is called LNG. Liquefied biomethane gas is called BioLNG. Methane from power-to-gas plants can also be liquefied.

The higher energy density of liquefied methane enables the use of methane as a fuel in applications such as heavy duty trucks, inland waterway and sea going ships, locomotives, rockets, other heavy machinery, distributed island mode power generation and potentially in aircraft. However, the internal combustion engines and fuel systems used for these applications have traditionally been designed mostly for diesel-like fuels. In order for such applications to use methane as fuel, the engines and fuel systems need to be modified to adapt to the fuel properties of methane.

It would be desirable to provide suitable liquefied methane-based fuel compositions which can be used in the types of applications mentioned above with enhanced fuel properties regarding the use in internal combustion engines.

While methane provides a high mass-specific energy content (about 15% higher than gasoline and diesel), it is not easy to ignite and therefore pure methane cannot be used in today's compression ignition engines used in energy efficient vehicles (trucks, ships, locomotives, and the like, as mentioned above). This is because self-ignition of methane happens at too high a temperature and the ignition delay times are too long. The only methane-fueled compression ignition engine types existing are high pressure direct injection engines using pilot diesel injection prior to methane injection (called HPDI or HPDF engines). The ignition of the methane fuel in such engines is enabled by pre-combustion of the pilot diesel fuel. This engine type needs a complex injection system, two fuel systems and more complex controls while not providing less exhaust treatment demand. This engine type cannot make full use of the potential CO₂ advantage of methane because some diesel fuel (pilot diesel) is still necessary. It would be desirable to provide an alternative liquefied fuel composition comprising methane which has improved combustion properties. This would allow internal combustion engines for methane-based fuels that need less additional energy for ignition (pilot) diesel demand, spark energy or other energy source. In the case of pilot diesel using engines, a lowering of particulate emissions might be achieved because of the reduced or eliminated pilot diesel demand.

In particular, it would be desirable to provide a liquefied methane-based fuel which is sufficiently self-igniting by reaction with oxygen such that internal combustion engines can be fueled by such a methane-based fuel without needing any additional energy source.

U.S. Pat. No. 7,614,385B2 relates to a compression ignition engine arranged to operate using a mixture of methane based gas and an ignition initiator, wherein the mixture is injected into a combustion chamber of the engine. There appears to be no mention in this document of the use of a liquefied methane based gas in a cryogenic state.

WO2004/087843 relates to compositions comprising mixtures of natural gas and dimethyl ether suitable for use as fuel compositions, and particularly to blends of dimethyl ether and a natural gas derived from LNG produced in an LNG process. There appears to be no disclosure in this document of the addition of dimethyl ether to a liquefied natural gas in cryogenic state.

### SUMMARY OF THE INVENTION

According to the present invention there is provided a fuel composition comprising (a) a major amount of liquefied methane based gas in cryogenic state having a temperature in the range from −182° C. to −100° C. and a pressure in the range of 1 bar to 15 bar, and (b) a minor amount of ignition improving additive, wherein the ignition improving additive has a melting point of less than −105° C., a boiling point of less than 60° C., an autoignition temperature of lower than 480° C. and is selected from alkanes, alkenes, alcohols, ethers, alkynes, aldehydes, ketones, amides, nitroalkanes, nitrosoalkanes, nitrates, nitrites, cycloalkanes, cycloalkenes, dienes, peroxides, triatomic oxygen, trimethylamine, ethylene oxide, propylene oxide, and mixtures thereof.

It has been found that, compared to conventional liquefied methane, the fuel composition of the present invention can surprisingly be prepared as a liquefied methane based fuel by solubilizing the ignition improving additive in the methane based fuel when it is in a cryogenic state. It has also surprisingly been found that the finished fuel composition containing the methane based fuel in cryogenic state and the ignition improving additive remains as a homogeneous mixture and does not not separate out.

The present invention also provides many other benefits as described herein. In particular, the fuel gas stream generated from this prepared liquefied fuel composition by evaporation provides a lower autoignition temperature or lower autoignition pressure, a faster ignition with lower autoignition delay times, and a reduction or elimination of the necessary external energy input such as spark, energy beam, pilot fuel or pyrophore substance, and the like, for ignition and re-ignition.

Further, the advantageous properties of the fuel composition of the present invention enable more efficient, less emitting and more powerful reciprocating, rotary and continuous combustion engines, if these engines are adapted to this fuel composition.

The fuel composition of the present invention can provide other secondary fuel property improvements relevant for engines and their fuel systems such as improved lubricity, higher volumetric energy density (in liquid/cryogenic or gaseous state) and advantages in terms of keeping engines and fuel systems clean, as compared with pure methane based liquefied fuel.

The fuel composition of the present invention can be advantageously used as a fuel in various types of internal combustion engines, in particular compression ignition internal combustion engines, for example in heavy duty trucks, inland waterway and sea going ships, locomotives, rockets, other heavy machinery, distributed island mode power generation and also potentially in aircraft.

According to a further aspect of the present invention there is provided a process for preparing the fuel composition herein, wherein the process comprises blending a major amount of liquefied methane based gas in cryogenic state having a temperature in the range from −182° C. to −100° C. and a pressure in the range of 1 bar to 15 bar with a minor amount of an ignition improving additive, wherein the ignition improving additive has a melting point of less than −105° C., a boiling point of less than 60° C., an autoignition temperature of lower than 480° C. and is selected from alkanes, alkenes, alcohols, ethers, alkynes, aldehydes, ketones, amides, nitroalkanes, nitosoalkanes, nitrates, nitrites, cycloalkanes, cycloalkenes, dienes, peroxides, triatomic oxygen, trimethylamine, ethylene oxide, propylene oxide, and mixtures thereof.

In the process of the present invention, the blending of the liquefied methane based gas with the ignition improving additive is preferably carried out at the LNG refueling station or downstream of the LNG liquefaction plant. Hence, in the process of the present invention, liquefaction of the methane based gas takes place before the ignition improving additive is blended into it. In other words, the liquefied methane based gas has already been liquefied before the ignition improving additive is blended into it.

According to a further aspect of the present invention there is provided the use of the fuel composition described herein for the purpose of fueling a compression ignition internal combustion engine, in particular with less or without the need for a pilot diesel fuel.

According to yet a further aspect of the present invention there is provided a method of operating a compression ignition internal combustion engine comprising fueling the compression ignition internal combustion engine with the fuel composition as described herein.

The features and advantages of the present invention will be apparent to those skilled in the art. While numerous changes may be made by those skilled in the art, such changes are within the spirit of the invention.

### BRIEF DESCRIPTION OF THE DRAWINGS

FIGS. 1 and 2 are plots that show the autoignition delay time versus the temperature for each of Examples 1 to 3.

FIG. 3 is a plot of the ignition delay time versus temperature for the fuel compositions shown in Table 2 (Examples 4-6) compared with DME.

FIG. 4 is a plot of the ignition delay time versus temperature for the fuel compositions shown in Table 3 (Examples 7-15) compared with DME.

FIG. 5 shows the predicted solid formation temperature against DME composition in methane and in the LNG mixture.

### DETAILED DESCRIPTION OF THE INVENTION

The fuel composition for use herein comprises a liquefied methane based gas.

As used herein the term ‘methane based gas’ means a substance which is gaseous at ambient temperature and pressure and which comprises a large proportion of methane. As used herein the term ‘ambient temperature and pressure’ means a temperature of 25° C. (298.15 K) and a pressure of 1.01325 bar. As used herein the term ‘a large proportion of methane’ means a content of methane preferably greater than 70 vol %, more preferably greater than 80 vol %, and most preferably greater than 90 vol %, based on the total amount of liquefied methane based gas.

The term ‘liquefied methane based gas’ as used herein means a methane based gas which is in a cryogenic state, i.e. it has a temperature in the range from −182° C. to −100° C., preferably from −160° C. to −100° C., more preferably from −160° C. to −110° C., even more preferably from −160° C. to 130° C. and especially from −160° C. to −135° C., and, preferably, a pressure in the range from 1 bar to 15 bar, more preferably in the range from 1 bar to 10 bar, and even more preferably in the range from 4 bar to 9 bar.

The liquefied methane based gas for use herein is preferably selected from liquefied natural gas, renewable liquefied methane gas, such as liquefied biomass derived methane, and liquefied synthetic methane from methanation processes, and mixtures thereof.

As used herein, the term ‘methane based gas’ means a gas comprising more than 50 vol % methane. Preferably, the methane based gas comprises at least 80 vol % methane, more preferably at least 85 vol % methane, even more preferably at least 90 vol % methane, and especially at least 95 vol % methane.

In a preferred embodiment herein, the liquefied methane based gas is liquefied natural gas.

The liquefied methane based gas is present in the fuel composition in a major amount. The term ‘major amount’ as used herein in relation to the liquefied methane based gas is meant at least 50 vol %. The liquefied methane based gas is preferably present in the fuel composition at a level in the range from 50 vol % to 99.99 vol %, more preferably from 60 vol % to 99.9 vol %, even more preferably from 70 vol % to 99.9 vol %, especially from 80 vol % to 98 vol %, even more especially from 90 vol % to 98 vol %, or from 95 vol % to 98 vol %, based on the total fuel composition.

The fuel composition may also contain other liquefied gases such as ethane, pentane, propane, butane and mixtures thereof, in addition to the liquefied methane based gas. These alkane gases may already be present in the liquefied methane based gas from the beginning of the production but could also be added to the liquefied methane based gas during production of the fuel composition in order to enhance combustion properties; in the latter case these alkane gases are considered as ignition improving additives.

An essential component of the fuel composition herein is an ignition improving additive. The ignition improving additive can be any additive which enhances the ignition properties of the liquefied methane based gas to which it is added. The ignition improving additive should be soluble in the liquefied methane based gas at a temperature at which the liquefied methane based gas is in a cryogenic state, i.e. at a temperature in the range from −182° C. to −100° C., preferably from −160 to −110° C., more preferably from −160° C. to −130° C., even more preferably from −160° C. to −135° C. and, preferably, at a pressure in the range from 1 bar to 15 bar, more preferably from 1 bar to 10 bar, and even more preferably from 4 bar to 9 bar.

The ignition improving additive enables the fuel composition to have significantly lower self-ignition temperatures and faster combustion (decreased ignition-delay times) than methane.

This property of the fuel composition supports the combustion of methane based fuels in all kinds of internal combustion engines and allows ease of ignition or re-ignition. Consequently lower external ignition energy is necessary, engine operation can be more reliable, emissions can be lower (particulates and hydrocarbon emissions). When used in compression ignition engines the present invention reduces the amount of pilot diesel demand or obviates the need for a pilot diesel fuel. In the latter case, only a mono-fuel and only one single injector per cylinder is needed.

The ignition improving additive for use herein must meet certain physical characteristics. The ignition improving additive for use herein has a melting point of less than −105° C., preferably less than −140° C., and a boiling point of less than 60° C., preferably less than 40° C. These melting point and boiling point criteria are important since they enable solubility of the ignition improving additive in the liquefied methane based gas when it is an a cryogenic state. In addition, these melting and boiling point criteria ensure that the resulting fuel composition will vaporize in the cryogenic pump onboard the vehicle (e.g. truck) or at the desired point in the system and not earlier or later.

As used herein, the term ‘soluble in liquefied methane based gas in its cryogenic state’ means that within a temperature range of −182° C. to −100° C. and preferably within a pressure range of 1 to 15 bar, the ignition improving additive is homogeneously distributed in the liquefied natural gas and stays in solution. In particular, the fuel composition exhibits no separation of the ignition improving additive during storage. Crystallization of the ignition improving additive or mixture of ignition improving additives must not occur, or any solid crystals that have formed must have dissolved in the liquefied methane based gas as the temperature increases up to −100° C. Solubility is dependent on the concentration of the ignition improving additive. The solid crystals that have formed must be below the detection limits as measured by professional imaging analysis equipment, for example, having a particle size of less than 7.17 microns as measured by VisiSize N60 laser imaging system supplied by Oxford Lasers Ltd.

In addition to the melting point and boiling point properties, the ignition improving additive also has an auto-ignition temperature which is significantly lower than that of methane (as measured by ASTM E659 which is a standard test method for measuring the auto-ignition temperature of chemicals). Preferably, the ignition improving additive for use herein has an auto-ignition temperature of lower than 480° C., more preferably lower than 450° C., even more preferably lower than 400° C., especially lower than 360° C. In a preferred embodiment herein the ignition improving additive has an auto-ignition temperature of 350° C. or less.

In addition, the ignition improving additive preferably has an ability to decrease the auto-ignition delay time of the fuel composition. The auto-ignition delay time can be measured by any suitable test method, such as by using shock tubes, Rapid Compression Machine (RCM) Testing, and the like. A preferred test method for measuring auto-ignition delay time herein is Rapid Compression Machine (RCM) Testing.

Preferred ignition improving additives for use herein have a molecular weight of less than 100 g/mol.

Suitable ignition improving additives for use herein are selected from alkanes, alkenes, alcohols, ethers, alkynes, aldehydes, ketones, amides, nitroalkanes, nitrosoalkanes, nitrates, nitrites, cycloalkanes, cycloalkenes, dienes, peroxides, triatomic oxygen, trimethylamine, ethylene oxide, propylene oxide, and mixtures thereof.

Preferred ignition improving additive for use herein is selected from alkanes, alkenes, ethers and aldehydes, nitrates and nitrites and mixtures thereof.

In one embodiment, the ignition improving additive for use herein is selected from alkanes, ethers and aldehydes, and mixtures thereof.

In another embodiment, the ignition improving additive for use herein is selected from alkanes, ethers, and mixtures thereof.

In another embodiment, the ignition improving additive for use herein is an ether.

In another embodiment herein, the ignition improving additive is a mixture of an ether and an alkane.

The ignition improving additive may also comprise a mixtures of one or more ignition improving additives.

Suitable ethers for use herein as an ignition improving additive include dimethyl ether, diethyl ether, methyl propyl ether, methyl isopropyl ether, ethyl vinyl ether, methyl ethyl ether, dimethoxymethane, methyl tert-butyl ether, polyoxymethylene dimethyl ether (PODE1) and mixtures thereof. A preferred ether for use herein is dimethyl ether.

Suitable alkanes for use as an ignition improving additive herein include propane, butane, isobutane, isopentane, pentane, 2,3-dimethylbutane, and mixtures thereof. As already mentioned above, it is recognized that small amounts of alkanes may already be present in the methane based gas together with the methane. Hence, in the context of the present invention, the term ‘ignition improving additive’ means an additive which is added on top of what may already be present in the methane based gas as it is supplied, and the amounts of ‘ignition improving additive’ specified herein refer to the amounts of ignition improving additive (e.g. alkanes) which are added on top of what may already be present in the methane based gas as supplied.

Suitable alkenes for use as an ignition improving additive herein include ethylene, pentene, propylene, 2-methyl-1-butene, 2-methyl-1-propene, 3-methyl-1-butene, trans-2-butene, 2-methyl-2-butene, 1-butene, cis-2-butene, 4-methyl-1-pentene, 2,3-dimethyl-1-butene, 3,3-dimethyl-1-butene, 3-methyl-1-pentene, 4-methyl-cis-2-pentene, 4-methyl-trans-2-pentene, 2-pentene, and mixtures thereof.

Suitable dienes for use as an ignition improving additive herein include isoprene, propadiene, 1,2-butadiene, 2,3-pentadiene, 3-methyl-1,2-butadiene, 1,3-butadiene, 1,2-pentadiene, 1,4-pentadiene, cis-1,3-pentadiene, 1,5-hexadiene, and mixtures thereof.

Suitable alkynes for use as an ignition improving additive herein include 1-butyne, 2-Methyl-1-buten-3-yne, 2-Pentyne, 1-Pentyne, Propyne, and mixtures thereof.

Suitable cycloalkanes and cycloalkenes for use as an ignition improving additive herein include cyclopropane, methylene cyclobutane, vinylcyclopropane, methylcyclobutane, cyclopentene, cyclopentadiene, spiropentane, and mixtures thereof.

Suitable aldehydes for use as an ignition improving additive herein include acetaldehyde.

Suitable nitrates for use as an ignition improving additive herein include alkyl nitrates and aryl nitrates, such as isopropyl nitrate, hexyl nitrate, and mixtures thereof.

Suitable nitrites for use as an ignition improving additive herein include N-propyl nitrite.

Another suitable ignition improving additive for use herein is selected from the group of compounds consisting of triatomic oxygen, trimethylamine, ethylene oxide, and propylene oxide.

In one embodiment herein the ignition improving additive is selected from dimethyl ether, acetaldehyde, propane, pentane, butane, DMM (dimethoxymethane), alkyl nitrites, and mixtures thereof.

In a preferred embodiment herein the ignition improving additive is selected from dimethyl ether, acetaldehyde and amyl nitrite, and mixtures thereof.

A particularly preferred ignition improving additive for use herein is dimethyl ether (DME).

The ignition improving additive is present in the fuel composition in a minor amount. As used herein, the term ‘minor amount’ in relation to the ignition improving additive means less than 50 vol %, based on the total fuel composition. The ignition improving additive is preferably present in the fuel composition at a level in the range from 0.01 to 15 vol %, more preferably from 0.1 to 10 vol %, even more preferably from 0.1 to 7 vol %, especially from 1 to 5 vol %, and more especially from 1 to 4 vol %, based on the total fuel composition.

As mentioned above, the amounts given above for the ignition improving additive refer to the amounts added to the methane based gas during production of the fuel composition and do not include any alkane components which may already be present in the methane based gas as supplied.

If the ignition improving additive comprises a mixture of one or more ignition improving additives, the concentrations above refer to the total amount of ignition improving additive in the fuel composition.

In a preferred embodiment herein, the ignition improving additive comprises a mixture of one or more ignition improving additives.

It should be noted that the amount of ignition improving additive present in the fuel is limited by solubility. The amount of ignition improving additive used should be soluble in liquefied methane based gas when it is in a cryogenic state at temperatures from −182° C. to −100° C.

The fuel compositions may be conveniently prepared using conventional formulation techniques by blending the ignition improving additive with the liquefied natural gas when the liquefied natural gas is in a cryogenic state, i.e. having a temperature in the range from −182 to −100° C., preferably in the range from −160 to −100° C., more preferably in the range from −160 to −110° C., and, preferably, a pressure in the range from 1 bar to 15 bar, more preferably from 1 bar to 10 bar. Advantageously, the ignition improving additive is selected such that it is soluble in the liquefied methane based gas when the liquefied methane based gas is in cryogenic state.

The fuel compositions of the present invention can be used for the purpose of fueling an internal combustion engine that is used in road transport, marine, mining, rail and aircraft applications, and the like.

Other fuel additives well known to those skilled in the art can also be included in the fuel composition, in addition to the ignition improving additive. Suitable examples of other fuel additives include detergents, corrosion inhibitors, viscosity index improvers, anti-foam agents, dispersants, friction modifiers, odorizers, colourants, and the like.

To facilitate a better understanding of the present invention, the following examples of certain aspects of some embodiments are given. In no way should the following examples be read to limit, or define, the entire scope of the invention.

### EXAMPLES

### Examples 1-15 (Autoignition Experiments)

Fuel compositions were prepared by blending pure methane with dimethylether (DME) in amounts as shown in Table 1 below.

TABLE 1

| Example | Additive | Vol % of additive | Vol % of methane |
|---|---|---|---|
| 1 | DME | 5 | 95% |
| 2 | DME | 3 | 97% |
| 3 | DME | 2 | 98% |

Autoignition experiments were performed on the fuel compositions shown in Table 1 using a rapid compression machine. The experimental conditions were as follows:

Pressure: 60 bar

Temperature: 750-900 K

Fuel/air ratio, λ:1.0, 0.5, 0.33, 0.25

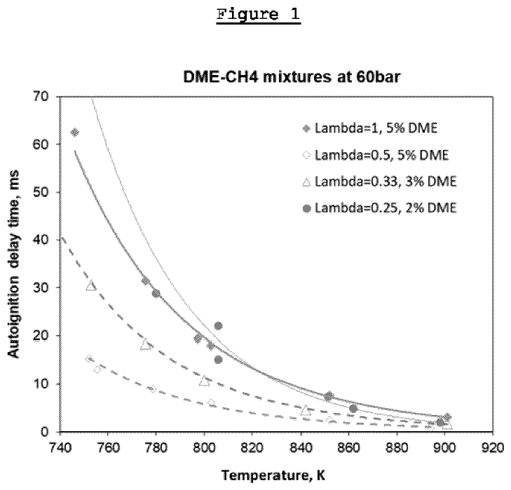

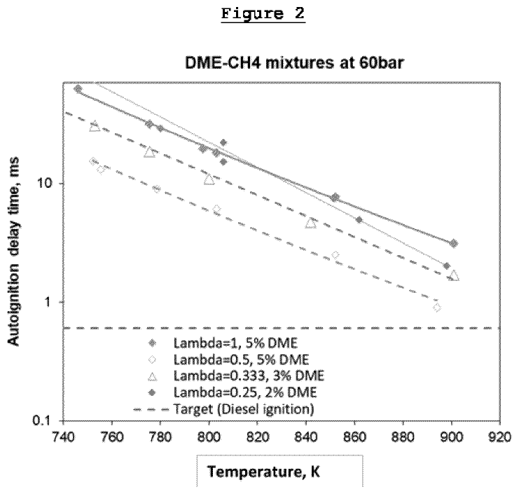

FIGS. 1 and 2 are plots that show the autoignition delay time versus the temperature for each of Examples 1-3.

Further fuel compositions were prepared by blending pure methane with acetaldehyde, dimethoxymethane (DMM) and iso-amyl nitrite (IAN) in amounts as shown in Table 2 below.

TABLE 2

| Example | Additive | Vol % of additive | Vol % of methane |
|---|---|---|---|
| 4 | Acetaldehyde | 2 | 98 |
| 5 | DMM | 2 | 98 |
| 6 | IAN | 0.5 | 99.5 |

Autoignition experiments were performed on the different fuel compositions shown in Table 2 using a rapid compression machine. The experimental conditions were as follows:

Pressure: 60 bar

Temperature: 750-900 K

Fuel/air ratio, λ:0.25

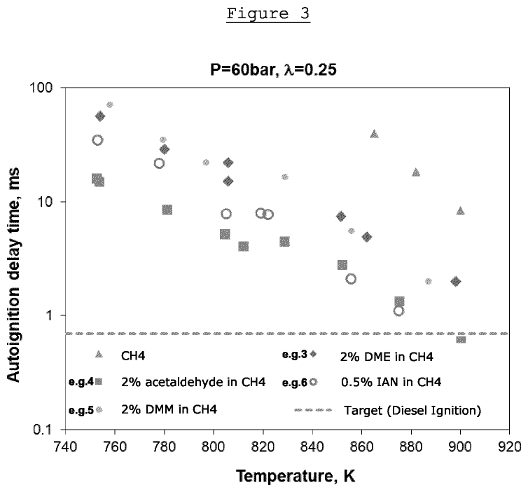

FIG. 3 is a plot of the ignition delay time versus temperature for the fuel compositions shown in Table 2 (Examples 4-6) compared with DME.

Further fuel compositions were prepared by blending natural gas with acetaldehyde, dimethoxymethane (DMM), iso-amyl nitrite, propane n-butane, ethane, n-pentane, isoprene in amounts as shown in Table 3 below.

TABLE 3

| Example | Additive | Vol % of additive | Vol % of methane |
|---|---|---|---|
| 7 | IAN | 1 | 99 |
| 8 | DME, Propane | 5% DME, 10% | 85 |
| | | propane | |
| 9 | DME, n- | 5% DME, 5% n- | 90 |
| | Pentane | Pentane | |
| 10 | DME | 5% DME in the | (see |
| | | LNG composition | composition in |
| | | shown in Table | Table 4) |
| | | 4) | |
| 11 | DMM | 5 | 95 |
| 12 | DME, n- | 5% DME, 10% n- | 85 |
| | butane | butane | |
| 13 | Acetaldehyde | 5 | 95 |
| 14 | DME, ethane | 5% DME, 10% | 85 |
| | | ethane | |
| 15 | Isoprene | 5 | 95 |

Autoignition experiments were performed on the different fuel compositions shown in Table 3 using a rapid compression machine. The experimental conditions were as follows:

Pressure: 60 bar

Temperature: 750-900 K

Fuel/air ratio, λ:0.25

TABLE 4
(Composition of LNG used in Example 10)

| | Mole % |
|---|---|
| Methane | 90.52 |
| Ethane | 6.32 |
| Propane | 2.63 |
| n-butane | 0.53 |

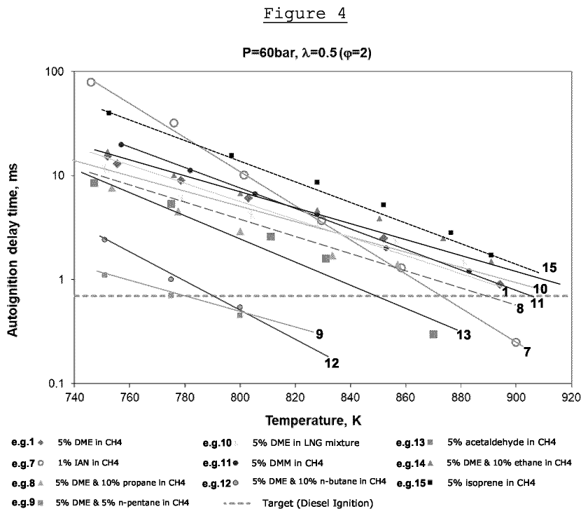

FIG. 4 is a plot of the ignition delay time versus temperature for the fuel compositions shown in Table 3 (Examples 7-15) compared with DME.

### Modelling to Determine at which Temperature DME Solid Formation Occurs, Using Gasvle (Examples 16-18)

GasVLE is a software package, commercially available from DNV-GL, that is used to predict the phase behaviour of gases, liquids, dense fluids, including natural gas and natural gas liquids. GasVLE can be used to generate thermodynamic data to predict phase behaviour and properties of both simple and complex hydrocarbon based mixture over a wide range of temperatures and pressures. Physical properties of natural gas and LNG are calculated based on composition, specified metering conditions and specified thermodynamic Equations of State. The solid formation temperature, or frost point, of a fluid mixture may be calculated.

The solid formation temperature of fuel compositions containing 4 mol %, 5 mol % and 6 mol % of DME in methane (Examples 18, 17 and 16 respectively) was calculated using GasVLE prior to solubility testing. The Peng-Robinson Equation of State was used as this is the preferred method for many studies for the solubility of compounds in LNG. The model predicts that DME at 6 mol % should be fully dissolved at typical LNG temperatures between 110 and 120 K (−163.15° C. to −153.15° C.). Table 5 below sets out the predicted solid formation temperatures for the different concentrations of DME.

TABLE 5

| | | | GasVLE solid |
|---|---|---|---|
| | | | formation |
| | | Additive amount | temperature |
| Example | Additive | fraction (mol %) | (K) |
| 16 | Dimethyl ether | 6 | 101.2 |
| 17 | Dimethyl ether | 5 | 99.1 |
| 18 | Dimethyl ether | 4 | 96.4 |

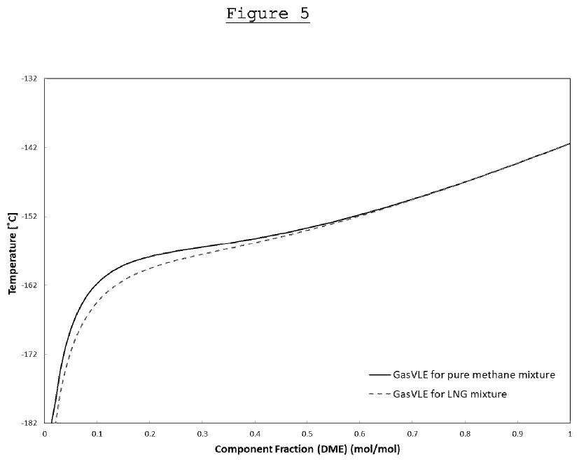

FIG. 5 shows the predicted solid formation temperature against DME composition (from 0 to 100 mol % DME) in methane and in the LNG mixture.

### Solubility Testing (on Examples 16-18)

In order to assess the solubility of selected ignition improving additives in liquefied natural gas in its cryogenic state, experiments were conducted using a gas expansion cryostat which allows cryogenic liquid hydrocarbon mixtures to be made in the laboratory. The cryostat is vacuum insulated and is cooled using a liquid nitrogen heat exchanger system. Cryogenic liquids may be produced by condensation directly through a port into a copper sample cell, or by expansion, where the gas mixture is condensed into a high pressure cell and expanded through a needle valve into the sample cell.

The copper sample cell has windows which allow non-intrusive measurements and observations to be made. The main piece of equipment used to take particle size measurements is a laser imaging system (VisiSize N60 laser imaging system supplied by Oxford Lasers Ltd.) which is capable of performing particle size distribution measurements and taking images.

The ignition improving additive which was tested in Examples 16-18 was dimethyl ether (DME). 6 mol % dimethylether in LNG in the gas phase was prepared gravimetrically by weighing the required amounts of pure components into a gas cylinder. ISO 6142 was used as the basis of the gravimetric method. The composition of the mixture is set out in Table 6 below.

TABLE 6

Amount fraction (mol %)

| Component | Mixture 1 | Mixture 2 |
|---|---|---|
| Nitrogen | 0.331 | 0.331 |
| Methane | 87.767 | 87.738 |
| Ethane | 5.783 | 5.781 |
| Propane | 0.151 | 0.151 |
| Dimethyl ether | 5.968 | 5.999 |

Typically, 50 to 100 g of LNG-DME gas mixture was added as this was sufficient to fill the copper sample cell above the bottom window used for observations and measurements. This 6 mol % DME mixture (Example 16) was diluted to liquid state to additive amount fractions of 5 mol % (Example 17) and 4 mol % DME (Example 18). To dilute the additive amount fraction, a predetermined amount of an LNG gas mixture without additive was condensed in the same way as above. The actual mass added was recorded so the resulting composition may be determined. The composition of the LNG gas mixture was such that the relative amount of each component (nitrogen, methane, ethane, propane) did not change as the additive amount fraction was reduced.

In order to sample the amount of fraction in the vapour phase (mol %), headspace samples were taken. The headspace results were analysed using a gas chromatograph by comparison to a calibration performed using the gravimetric LNG-additive gas mixture with a known amount fraction.

A maximum of two experiments was anticipated. If solids were observed in the first experiment, particle size measurements were made and the solubility of the additive was determined by diluting the additive and increasing the temperature until the solids had dissolved. The conditions for solubility (temperature, additive amount fraction) were recorded. In the second experiment, the headspace composition was measured at different amount fractions of additive.

### Results of Solubility Testing

For Examples 16-18 (containing DME), the solid melting temperature range for DME was determined at each concentration. For 5 and 6 mol % DME (Examples 17 and 16, respectively), the temperature was increased until all the solids were dissolved. Whereas for 4 mol % DME (Example 18), the temperature was decreased to determine the temperature at which solids first appear, then increased to find the temperature at which the solids first begin to dissolve. The results are shown in Table 7 below. For Examples 17-18, the amount of fraction additive in the vapour phase (mol %) is shown in Table 7.

TABLE 7

| | | | Temperature | Amount of |
|---|---|---|---|---|
| | | Amount | at which | fraction |
| | | fraction of | solids | additive in |
| | | additive | dissolve | vapour phase |
| Example | Additive | (mol %) | (K) | (mol %) |
| 16 | Dimethyl ether | 6 | 121-123 | nm |
| 17 | Dimethyl ether | 5 | 118-120 | 0.0193 |
| 18 | Dimethyl ether | 4 | 113-118 | 0.0259 |

nm = not measured

### Discussion

FIGS. 1 and 2 show the results for testing DME at different concentrations, from Examples 1-3, for different fuel-air ratios. FIG. 1 shows the measured autoignition delay time on a normal scale whereas in FIG. 2, the measured autoignition delay time is on a logarithmic scale.

FIG. 3 shows the impact of different additives on the autoignition delay times of the methane based gaseous fuel compositions (DME 2% vol, Acetaldehyde 2% vol.; DMM 2% vol.; Iso-Amylnitrite (IAN) 0.5% vol). Fuel compositions containing Acetaldehyde, DMM and DME can be considered representative of the fuel compositions of the present invention because the additives therein fulfil the criteria regarding melting point, boiling point and autoignition temperature. Fuel compositions containing IAN fall outside the scope of the invention (IAN does not fulfil the criteria of boiling point, melting point and autoignition temperatures as defined by the present invention).

FIG. 4 shows similar results for different test conditions (lambda 0.5) and includes tests with mixtures of additives. The compositions, except that with IAN, shown in FIG. 4 fall within the scope of the present invention. Again, all the fuel compositions shown in FIG. 4 (Examples 7-15) improve the ignition of the methane based fuel significantly. The fuel compositions consisting of methane with 10 vol % butane and 5 vol % DME (Example 12) and methane with 5 vol % DME and 5 vol % pentane (Example 9) show the best ignition improvement. Hence the fuel compositions containing combinations of different additive exhibit even further improved ignitability of methane based fuels.

Examples 16-18 show that concentrations of 4-6 mol % Dimethyl ether (which has a melting point of −141.5° C.) form a homogeneous solution in the liquefied natural gas when it is in a cryogenic state, i.e. at a temperature in the range from −182° C. to −100° C. With an LNG mixture containing 6 mol % dimethyl ether (Example 16), dimethyl ether crystals dissolved when temperatures in the range of 121 to 123 K (−152.15° C. to −150.15° C.) were reached. With an LNG mixture containing 5 mol % dimethyl ether (Example 17), dimethyl ether crystals dissolved when temperatures in the range 118 to 120 K (−155.15° C. to −153.15° C.) were reached. With an LNG mixture containing 4 mol % dimethyl ether (Example 18), dimethyl ether crystals dissolved when temperatures in the range of 113 to 118 K (−160.15° C. to −155.15° C.) were reached. These experiments show that DME meets the solubility requirements required by the present invention, i.e. it is soluble in LNG when in a cryogenic state, and further that it reduces the autoignition delay time of LNG.

We claim:

1. A fuel composition comprising (a) a major amount of liquefied methane based gas in cryogenic state having a temperature in the range from −182° C. to −100° C. and, preferably, a pressure in the range of 1 bar to 15 bar, and (b) a minor amount of an ignition improving additive, wherein the ignition improving additive has a melting point of less than −105° C., a boiling point of less than 60° C., an autoignition temperature of less than 480° C. and wherein the ignition improving additive is selected from alkanes, alkenes, alcohols, ethers, alkynes, aldehydes, ketones, amides, nitroalkanes, nitrosoalkanes, nitrates, nitrites, cycloalkanes, cycloalkenes, dienes, peroxides, triatomic oxygen, trimethylamine, ethylene oxide, propylene oxide, and mixtures thereof.

2. A fuel composition according to claim 1 wherein the ignition improving additive is selected from ethers, aldehydes, nitrites, alkenes and alkanes, and mixtures thereof.

3. A fuel composition according to claim 1 wherein the ignition improving additive is selected from ethers and alkanes, and mixtures thereof.

4. A fuel composition according to claim 1 wherein the ethers are selected from dimethyl ether, diethyl ether, methyl propyl ether, methyl isopropyl ether, ethyl vinyl ether, methyl ethyl ether, dimethoxymethane, methyl tert-butyl ether, polyoxymethylene dimethyl ether (PODE1) and mixtures thereof.

5. A fuel composition according to claim 1 wherein the ignition improving additive is selected from dimethyl ether, acetaldehyde, alkyl nitrates, aryl nitrates and mixtures thereof.

6. A fuel composition according to claim 1 wherein the liquefied methane based gas is selected from liquefied natural gas, liquefied biomethane gas and liquefied synthetic methane, and mixtures thereof.

7. A fuel composition according to claim 1 wherein the liquefied methane based gas has a temperature in the range from −160° C. to −100° C.

8. A fuel composition according to claim 1 wherein the liquefied methane based gas has a pressure in the range from 1 bar to 10 bar.

9. A fuel composition according to claim 1 wherein the ignition improving additive is present at a level of from 0.01 to 15 vol %, preferably from 0.1 to 10 vol %, more preferably from 0.1 to 7 vol %, based on the total fuel composition.

10. A fuel composition according to claim 1 wherein the ignition improver is dimethyl ether.

11. Process for preparing the fuel composition according to claim 1, the process comprising blending a major amount of liquified methane based gas in cryogenic state having a temperature in the range from −182° C. to −100° C. and, preferably, a pressure in the range of 1 bar to 15 bar, with a minor amount of ignition improving additive, wherein the ignition improving additive has a melting point of less than −105° C., a boiling point of less than 60° C., an autoignition temperature of lower than 480° C., and wherein the ignition improving additive is selected from alkanes, alkenes, alcohols, ethers, alkynes, aldehydes, ketones, amides, nitroalkanes, nitosoalkanes, nitrates, nitrites, cycloalkanes, cycloalkenes, dienes, peroxides, triatomic oxygen, trimethylamine, ethylene oxide, propylene oxide, and mixtures thereof.

12. Process according to claim 11 wherein blending of the major amount of liquefied methane based gas with the ignition improving additive takes place at an LNG refueling station or downstream of the LNG liquefaction plant.

13. Process according to claim 11 wherein the liquefied methane based gas has already been liquefied before the ignition improving additive is blended into it.

14. Use of the fuel composition according to claim 1 for the purpose of fueling a compression ignition internal combustion engine, in particular without the need for a pilot diesel fuel.

15. Method of operating a compression ignition internal combustion engine comprising fueling the compression ignition internal combustion engine with a fuel composition according to claim 1.
